(19) United States
(12) Patent Application Publication
(10) Pub. No.: US 2010/0275702 A1
(43) Pub. Date: Nov. 4, 2010

(54) ROTARY VALVE

(75) Inventors: Kevin W. Kinback, Turnersville, NJ (US); James W. Stannard, Pittsgrove, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS WATER TECHNOLOGIES CORP., Warrendale, PA (US)

(21) Appl. No.: 12/514,004

(22) PCT Filed: Nov. 8, 2007
(86) PCT No.: PCT/US2007/023586

§ 371 Date: Jul. 16, 2010

Related U.S. Application Data
(60) Provisional application No. 60/864,887, filed on Nov. 8, 2006.
(60) Provisional application No. 60/864,885, filed on Nov. 8, 2006.

(51) Int. Cl. G01F 1/42; F16K 5/08

(52) U.S. Cl. 73/861.61; 251/304

(57) ABSTRACT

Systems and methods for metering fluid flow are disclosed. A valve may generally include an orifice plate, and a disc positioned adjacent to the orifice plate. An orientation of the disc relative to the orifice plate is adjustable to regulate a fluid flow rate through the valve. An effective area of an aperture in the orifice plate may be manipulated to adjust the fluid flow rate. In some configurations, the valve may provide sonic flow control or differential pressure regulation. In some applications, a controller may adjust the orientation of the disc relative to the orifice plate to maintain a substantially constant pressure drop across the orifice plate in order to determine a fluid flow rate through the valve.

### FIELD OF THE TECHNOLOGY

The present invention relates generally to the field of fluid mechanics and, more particularly, to systems and methods for metering fluid flow.

### BACKGROUND

Valves function to regulate fluid flow in fluid feed systems by generally opening, closing and partially obstructing flow passageways. Many different types of valves are available, suited for a variety of applications. A valve typically includes a valve body which houses a movable component, the position of which may be altered to control flow. A needle valve is one type in which a threaded plunger is retractably received by an orifice. Likewise, a plug valve involves a cylindrically-shaped or conically-tapered plug that is vertically received by a complimentary orifice to regulate flow. Conventional valves typically require precise feedback when accurate control is desired. For example, additional mechanisms such as a motion pot to determine placement of the movable component relative to the orifice, and a rotameter to verify flow rate, may be necessary. In addition to accuracy, valve cost and reliability are also important design considerations, particularly in the low capacity gas feed market which is an emerging segment.

### SUMMARY

Aspects and embodiments relate generally to systems and methods for metering fluid flow.

In accordance with one or more embodiments, a rotary valve may comprise an orifice plate configured to facilitate fluid flow through the valve, and a disc, positioned adjacent to the orifice plate, constructed and arranged to cooperate with the orifice plate to regulate a fluid flow rate through the valve.

In accordance with one or more embodiments, a method of metering fluid flow may comprise fluidly connecting a fluid source to a valve comprising an orifice plate and a disc positioned adjacent to the orifice plate, and adjusting an orientation of the disc relative to the orifice plate to establish a predetermined fluid flow rate through the valve.

In accordance with one or more embodiments, a fluid flow rate measurement device may comprise an orifice plate configured to facilitate fluid flow through the device, a disc, positioned adjacent to the orifice plate, constructed and arranged to cooperate with the orifice plate to maintain a substantially constant pressure drop across the orifice plate, and a controller configured to detect a fluid flow rate through the device based on an orientation of the disc relative to the orifice plate.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures. In the figures, which are not intended to be drawn to scale, each identical or nearly identical component that is illustrated in various figures is represented by a like numeral. For purposes of clarity, not every component may be labeled in every drawing. The figures are provided for the purposes of illustration and explanation and are not intended as a definition of the limits of the invention. In the figures:

FIG. 1 is an exploded view of a rotary valve in accordance with one or more embodiments;

FIG. 2 is a perspective view of a disc in mechanical cooperation with an orifice plate in accordance with one or more embodiments;

FIGS. 3A and 3B present cross-sectional views of a valve, each having a different fluid flow passageway, in accordance with one or more embodiments;

FIG. 4 is a perspective view of a rotary valve disc in accordance with one or more embodiments;

FIG. 5 is a perspective view of a rotary valve configured to provide sonic flow regulation in accordance with one or more embodiments;

FIG. 6 is a perspective view of a rotary valve configured to provide differential pressure flow regulation in accordance with one or more embodiments; and

FIG. 7 is a perspective view of a rotary valve incorporated into a flow rate measurement device in accordance with one or more embodiments.

### DETAILED DESCRIPTION

One or more aspects and embodiments relates generally to systems and methods for metering fluid flow. The systems and methods described herein may find applicability in a wide variety of industries in which there may be a demand for flow rate control and/or monitoring. Beneficially, one or more aspects may provide predictable operability over a broad range of flow rates, with enhanced resolution and accuracy. In some aspects, linearized fluid flow control may be achieved without requiring system feedback. The metering systems and methods may also provide substantial advantages in terms of design, ease of manufacture and cost.

It is to be appreciated that embodiments of the systems and methods discussed herein are not limited in application to the details of construction and the arrangement of components set forth in the following description or illustrated in the accompanying drawings. The systems and methods are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

Embodiments and aspects of disclosed systems and methods may generally include a valve configured to meter fluid flow. The valve may generally be positioned on a fluid feed line. In some aspects, the valve may be positioned proximate to a source of a fluid. In some embodiments, the valve may provide a fluid at a desired flow rate. For example, the valve may establish and/or maintain a predetermined flow rate. In other embodiments, the valve may facilitate determination and/or monitoring of a fluid flow rate as discussed further below.

The valve may generally involve a valve body or housing having ports, including but not limited to an inlet and an outlet. The inlet may be fluidly connected to a source of any fluid to be fed or metered, such as a liquid or a gas. In some non-limiting embodiments, the fluid may be a gas, for example, chlorine, carbon dioxide or sulphur dioxide. The valve and components thereof may be constructed of any material, but should be compatible with environmental conditions associated with an intended application, such as temperature, pressure and characteristics of any chemicals which may contact the valve, including the fluid to be metered by the valve. In some embodiments, the valve may be made of polyvinylchloride (PVC) or other similar material.

In accordance with one or more aspects, the valve may generally define a fluid flow pathway along which a fluid travels through the valve. One or more features or elements of the valve may generally be configured to facilitate fluid flow through the valve along the pathway. In some embodiments, for example, the valve may include a plate, such as an orifice plate, along the fluid pathway configured to facilitate fluid flow through the valve. More specifically, the orifice plate may generally include one or more apertures through which a fluid stream may travel. The size, number, geometry and orientation of the aperture may vary depending on an intended application. For example, the aperture may be substantially round, square, triangular or of any other geometry. In at least one embodiment, the aperture may have the shape of a substantially equilateral triangle. As discussed in greater detail below, one or more characteristics of the aperture, such as its geometry, may generally facilitate linearization of fluid flow control through the valve. In some aspects, it may be beneficial to select an aperture with a geometry that may be varied so as to facilitate linearization. In some embodiments, an orifice plate with a specific aperture size may be selected based on a desired flow rate range or resolution as discussed further below. Thus, orifice plates may be sized to accommodate a particular flow rate range or peak flow rate. The orifice plate may be integral to the valve housing or may be a discrete valve component. The orifice plate may be positioned at any point along the fluid flow pathway of the valve. In some embodiments, a valve may include multiple orifice plates.

A fluid flow rate through the valve may be established, regulated and/or controlled in various ways, for example, by an operation upstream or downstream of the valve. In some embodiments, the valve itself may be configured to establish and/or adjust a fluid flow rate. In accordance with one or more embodiments, the valve may include one or more features or elements configured to regulate a fluid flow rate through the valve. In some aspects, a fluid flow rate may be a desired or a predetermined flow rate, such as may be based on an intended application. A fluid flow rate may be constant or may vary over a range of values. In some non-limiting embodiments, the flow rate may be in a range from about 0 to about 10,000 ppd (0-190 Kg/h). In some embodiments, the flow rate may be in a range from about 0 to about 500 ppd (0-10 Kg/h). In at least one embodiment, the flow rate may be in a range from about 0 to about 3 ppd (0-60 g/h).

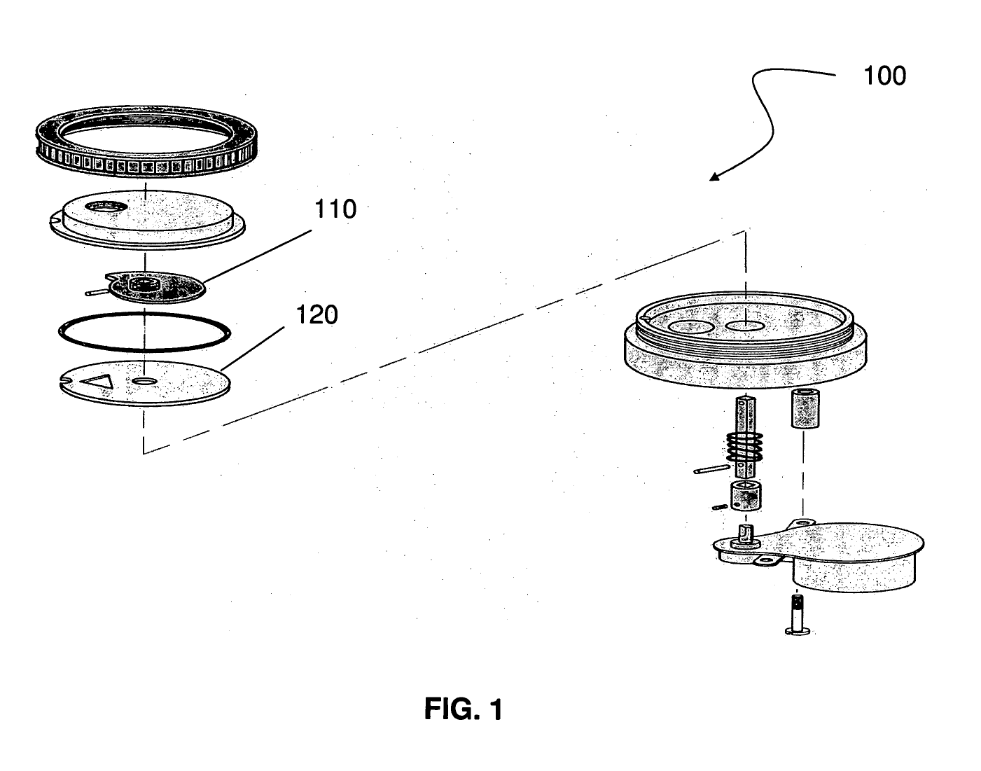

In accordance with one or more embodiments, the valve may include one or more features or elements configured to cooperate with an orifice plate in order to regulate a fluid flow rate through the valve. For example, with reference to FIG. 1, a valve 100 may include a disc 110 constructed and arranged to cooperate with an orifice plate 120 to regulate a fluid flow rate through the valve. The disc 110 may generally be positioned adjacent to the orifice plate 120. In some aspects, the disc 110 may be sealingly coupled to the orifice plate 120 so as to generally inhibit fluid leakage. The valve may include various other elements, such as gaskets, nuts, caps, seals and other commonly known valve components. In some embodiments, a spring may hold the disc 110 in position against the orifice plate 120.

In accordance with one or more embodiments, an orientation or position of the disc relative to the orifice plate may be adjustable to regulate a fluid flow rate through the valve. In some aspects, the disc and orifice plate may generally be rotatable or pivotable with respect to one another. For example, one or more pivot or other fixed points may facilitate adjustment of the orientation of the disc relative to the orifice plate. A pivot point may be substantially centered, or may be at any other position, relative to a cross section of the valve. In at least one embodiment, one of the disc and orifice plate may be fixed, while the other is movable. For example, a disc may be rotatable relative to a fixed orifice plate. Alternatively, both the disc and the orifice plate may be movable. According to some aspects, one or both of the orifice plate and disc may be in mechanical communication with a shaft or like device to generally facilitate adjusting their relative orientation. In at least one embodiment, the disc and/or orifice plate may be freely movable, such as freely rotatable. In other embodiments, a fixed range of motion may be established. By way of a non-limiting example, the disc may be configured to rotate up to 90, 180 or 360 degrees relative to the orifice plate. Thus, in some embodiments the valve may be generally referred to as a single-turn valve.

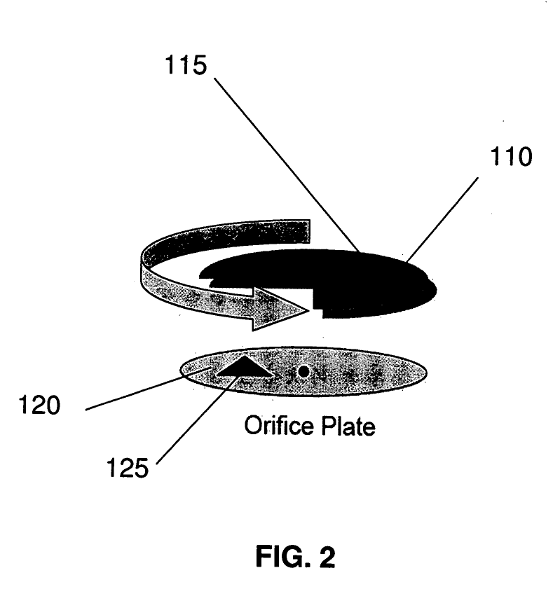

Certain embodiments and aspects may generally involve establishing, manipulating and/or adjusting an effective area of an aperture in the orifice plate to regulate a fluid flow rate through the valve. With reference to FIG. 2, an orifice plate 120 may generally include an aperture 125 to facilitate fluid flow through the valve, as discussed above. A full potential area of aperture 125 may be defined by the geometry of orifice plate 120. The full potential area of aperture 125 may be adjusted or modified in accordance with one or more embodiments resulting in an effective area of the aperture. For example, disc 110 may be used to adjust an effective area of aperture 125 as discussed in greater detail below. In some aspects, an effective area of the aperture may generally define or impact a fluid flow pathway through the valve. In turn, characteristics and/or dimensions of the fluid flow pathway may impact or affect a fluid flow rate through the valve. For example, an aperture with a large effective area may generally provide a less obstructed fluid flow path, thus promoting higher fluid flow rates. On the other hand, an aperture with a relatively small effective area may generally provide a more obstructed fluid flow path, thus hindering higher fluid flow rates. An effective area of aperture 125 may generally range from 0 to 100% of its full potential area, such as may be defined by the geometry of orifice plate 120. A flow rate of zero may generally be associated with a zero effective aperture area, while a peak flow rate may be associated with a maximum effective area for any given aperture. Thus, for a given orifice plate aperture, a range of flow rates may be achieved by adjusting an effective area of the aperture. As discussed in greater detail below, flow rate may beneficially be linearized with respect to the effective aperture area for enhanced accuracy and resolution of flow rate control. In some aspects, different orifice plates may accommodate different flow rate ranges, as may be based on a size of their aperture. An orifice plate may be selected based on a desired flow rate range or desired flow rate resolution.

The effective area of the aperture may be manipulated in various ways. In some aspects, the disc 110 may cooperate with the orifice plate 120 to modify or adjust an effective area of aperture 125. For example, an orientation of disc 110 relative to orifice plate 120 may be adjusted to modify an effective area of the aperture 125. In some embodiments, the disc 110 may be rotatable relative to the orifice plate 120, or vice versa, to adjust the effective area of the aperture, as illustrated in FIG. 2 and discussed in greater detail below. In at least one aspect, an effective area of a triangular aperture may be adjusted by altering an effective height of the triangle.

The disc 110 may generally be of any shape, size and configuration. In some aspects, the shape or geometry of disc 110 may generally be protean in nature. In some embodiments, the disc 110 may include an edge, segment, element or feature 115 configured to adjust or manipulate an affective area of the orifice plate aperture 125. (See FIG. 2.) For example, the disc segment 115 may engage or cooperate with at least a portion of the orifice plate aperture 125 to establish an effective area of the aperture 125. In at least one embodiment, disc segment 115 may generally overlap with, block or obstruct at least a portion of the aperture 125 to adjust its affective area. In some embodiments, segment 115 may, in effect, serve as a boundary of aperture 125, such as a portion of a perimeter of aperture 125. For example, in some non-limiting embodiments wherein the aperture 125 is substantially triangular in shape, segment 115 may form one side of the triangle. In some aspects, segment 115 may be a movable boundary of aperture 125, generally capable of adjusting its effective area. Manipulating an orientation of the disc 110 relative to the orifice plate 120, such as through rotation, may therefore impact an orientation of the disc segment 115 relative to the orifice plate aperture 125 to adjust an effective area of the aperture 125. Adjusting an effective area of the aperture 125 may, in turn, adjust a fluid flow rate through the valve.

In some embodiments, disc 110 may be identical to or may otherwise resemble an orifice plate 120. For example, disc 110 and orifice plate 120 may each include an aperture. The orientation of disc 110 and orifice plate 120 relative to one another may be adjusted or manipulated to control flow rate. In some aspects, disc 110 and/or orifice plate 120 may be rotated so as to adjust an orientation of the apertures thereof to control or regulate flow rate. More specifically, the aperture of the orifice plate 120 may at least partially engage with the aperture of the disc 110, for example, so as to merge into a single effective aperture, the size of which may be manipulated to regulate flow. The disc 110 and aperture plate 120 may be rotated with respect to one another so as to adjust the size of the single effective aperture to regulate flow. Increasing the size of the single effective aperture may generally correlate to an increasing flow rate while decreasing the size of the single effective aperture may generally correlate to a decreasing flow rate.

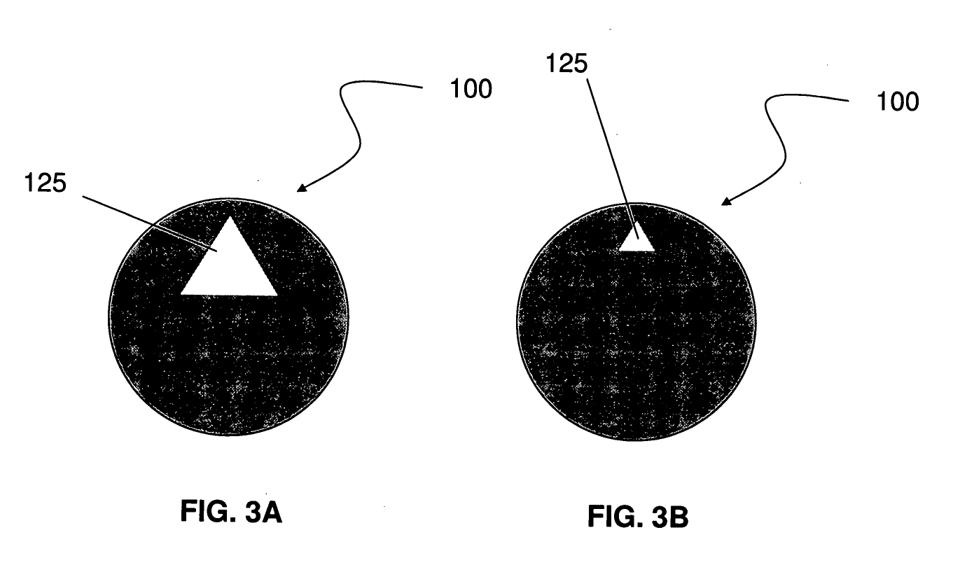

In operation, therefore, orientation of disc 110 relative to orifice plate 120 may be adjusted so as to increase an effective area of aperture 125 when increased fluid flow rate is desired, or so as to decrease an effective area of aperture 125 when decreased flow rate is desired. In some aspects, the valve may generally be considered a two-dimensional valve in accordance with one or more embodiments in that the orientation of the disc 110 relative to the orifice plate 120 may generally manipulate fluid flow rate. In some embodiments, as discussed above, the valve may be a single-turn rotary valve, wherein a full range of flow rates associated with a given orifice plate may be achieved through 360 degrees of rotation. For example, FIG. 3A may generally be associated with higher fluid flow rates than that of FIG. 3B. FIG. 3A may represent a peak flow rate. FIG. 3B may represent a relatively lower fluid flow rate as may be due to at least partial obstruction of a fluid pathway of the valve, such as through rotation of a disc relative to an orifice plate. FIGS. 3A and 3B each illustrate different effective areas of an aperture 125.

In at least one embodiment, the disc 110 and the orifice plate 120 may involve substantially complimentary geometries to facilitate cooperation so as to regulate a fluid flow rate through the valve. For example, complimentary geometries between the disc 110 and the orifice plate 120 may facilitate adjusting an effective area of aperture 125 in the orifice plate 120 so as to regulate a fluid flow rate through the valve. In some non-limiting embodiments, the aperture 125 may generally be triangular in geometry, as illustrated in FIG. 2. As discussed above, the disc 110 may include a section 115, such as an edge or wedge that may be moved into a desired position so as to define a boundary of the triangular aperture 125, thus establishing its effective area. In some aspects, the effective area of the aperture 125 may be adjusted by rotating the disc 110 relative to the orifice plate 120 to adjust a flow rate through the valve. Other geometries may be implemented in accordance with one or more embodiments.

In accordance with one or more embodiments, disc 110 may have an outer periphery defined by a number of adjacent and decreasing radii. In some aspects, positions around a periphery of disc 110 may descend from a maximum radius to a minimum radius. In at least one embodiment, disc 110 may include a notch or indentation. The notch may generally be defined by the geometry or perimeter of disc 110. In some aspects, one side of the notch may be defined by at least a portion of a maximum disc radius. Disc 110 may cooperate with an orifice plate 120 to regulate fluid flow rate. Disc 110 may be rotatable about orifice plate 120 to adjust an effective area of an aperture 125 in the orifice plate 120. In some aspects, disc 110 may be rotated in a direction so as to advance a progressively increasing radius to decrease an effective area of aperture 125, thus decreasing fluid flow rate. When a maximum radius of disc 110 engages aperture 125, an effective area of the aperture may be substantially zero which may correspond to substantially no fluid flow. Likewise, disc 110 may be rotated in a direction so as to advance a progressively decreasing radius to increase an effective area of aperture 125, thus increasing fluid flow rate. When a minimum radius of disc 110 engages aperture 125, an effective area of the aperture may be a full size of the aperture which may correspond to a peak flow rate for which the orifice plate 110 is sized. A decreasing disc radius may generally correlate to an increasing fluid flow rate, while an increasing disc radius may generally correlate to a decreasing fluid flow rate.

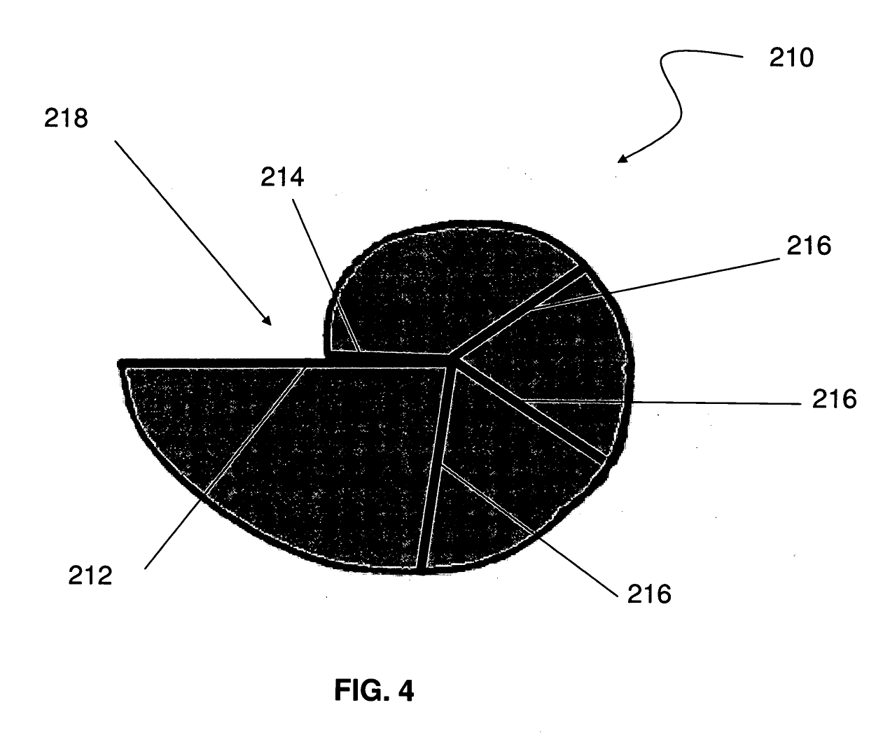

FIG. 4 illustrates one non-limiting embodiment of a valve disc 210. Disc 210 may generally include a maximum radius 212 adjacent to a minimum radius 214. Disc 210 may also include a plurality of intermediate radii 216. In some aspects, each intermediate radius 216 may be adjacent to another intermediate radius on each side. An intermediate radius 216 may be adjacent to a relatively larger intermediate radius on one side, and adjacent to a relatively smaller intermediate radius on another side. Thus, disc 210 may generally include a number of adjacent and decreasing radii, ranging from maximum radius 212 to minimum radius 214. In some aspects, disc 210 may generally include a notch or indentation 218, in which one side of the notch 218 has a length equal to at least a portion of maximum radius 212.

In some embodiments, disc 110 having a decreasing radius may be rotatable 360 degrees with respect to an orifice plate 120. Angular position of disc 110 with respect to orifice plate 120 may correlate to a fluid flow rate through the valve. For example, an angular position of zero or 360 degrees may correlate to either a peak flow rate, or a zero flow rate. A range of angular positions between zero and 360 degrees may correlate to a range of flow rates between zero and a peak flow rate. In some aspects, angular position may correlate to an effective aperture area, or to an effective aperture height. For example, a minimum disc radius as may be based on angular position may correlate to a maximum aperture area or height while a maximum disc radius as may be based on angular position may correlate to a minimum aperture area or height. A range of aperture areas or heights may correlate to a range of flow rates between zero and a peak flow rate. Different orifice plates may be associated with different peak and/or low flow rates.

In one embodiment, a disk may have a number of short straight lines around its perimeter, such as may reflect incremental radius changes rather than a continuously changing radius. In some aspects, this disc may provide linear flow rate adjustment when rotation of the disk relative to the orifice plate is incremental, such as through use of a stepper motor. The number of straight edges along its outer periphery may dictate achievable resolution of flow rate variation. More straight edges may correlate with increased achievable flow rate control and/or variability.

In certain aspects, a fluid flow rate through the valve may be substantially linear with respect to orientation of a disc relative to an orifice plate. For example, the geometries of the disc and orifice plate may be such that their relative orientation yields a linear relationship with respect to flow rate through the valve. In some aspects, fluid flow rate through the valve may be linear with respect to an effective area of an orifice plate aperture. Preferably, complimentary geometries for the orifice plate and disc may be selected such that adjusting their orientation relative to one another establishes a fall-off with respect to flow rate and/or effective area which may be linearized. This may beneficially provide predictability, accuracy and resolution in flow rate control. In some non-limiting embodiments, flow rate may be linearized with respect to any one or more of effective aperture area, effective aperture height, or angular position of a disc with respect to an orifice plate.

In accordance with one or more embodiments, a theoretical linear relationship may be established based on known principles of fluid mechanics, including but not limited to Bernoulli's Law. Expected operating conditions and properties of a fluid to be metered may be factored into developing a theoretical linear relationship. For example, when a triangular aperture is to be used, a linear relationship may be established relating flow rate to an effective area or height of the triangular aperture. A disc may then be prepared based on the theoretical linear relationship. For example, a disc may be prepared that is capable of cooperating with an orifice plate to facilitate adjustment of the effective area or height of the triangle based on the linear relationship to regulate flow rate. Actual measurements and experimentation may then be used to correct for any nonidealities, such as may be due to system geometry, to adjust and perfect the linear relationship. In some aspects, with disc 110 including a gradually changing radius, one side of an effective area of a triangular aperture 125 may technically be curved, as may be due to at least partial obstruction by disc 110, but this may be negligible and/or ignored in determining the linear relationship. Changes may be made to the disc to correct for nonidealities, and a master disc may then be created and easily replicated by known methods, such as die cut, mold and other techniques. Based on an established linear relationship, a desired flow rate may be achieved by orienting a disc relative to an orifice plate in a corresponding known position. Thus, in some aspects valve output may generally be linear with respect to angular position of a disc relative to an orifice plate. For example, in at least one embodiment, a 50% rotation may result in a flow rate that is about 50% of a designed peak flow rate, and a 25% rotation may result in a flow that is about 25% of a designed peak flow rate.

The orientation of the disc relative to the orifice plate may be manually established. Alternatively, adjustment may be made automatically. For example, the disc and/or orifice plate may be moved relative to one another by a motor, such as by a stepper motor. In at least one embodiment, the disc may be in mechanical communication with a stepper motor, such as through an attached shaft. In some embodiments, the motor may be in electrical communication with a controller.

In accordance with one or more aspects, the controller may be programmed with an established linear relationship, or information to facilitate determination of a linear relationship. For example, a linear relationship may be established such that each increment or step of the stepper motor is correlated to a known fluid flow rate. In some aspects, this linearity may involve a relationship between fluid flow rate and relative orientation of disc to orifice plate. In other aspects, the relationship may generally be described as being between fluid flow rate and an effective area of the orifice plate aperture. In some non-limiting embodiments, a desired flow rate may be inputted to the controller, and a control signal may be sent to the stepper motor to establish the desired flow rate by automatically adjusting a position of the disc relative to the orifice plate, or by automatically adjusting an effective area of the orifice plate aperture. The stepper motor may include any number of steps. In some embodiments, the stepper motor may include at least about 50 steps. In at least one embodiment, the stepper motor may include at least about 100 steps. In some aspects, the stepper motor may include 500 or more steps. Thus, turn-down ratios of at least about 100:1 may be established. For example, with a 10:1 turndown ratio, fluid control may be linear, with respect to valve position, down to about 10% of a peak flow rate.

In accordance with one or more embodiments, a disclosed valve may be part of a larger fluid feed system, such as a gas feed system in which metered flow is required. In at least one embodiment, a gas feed system including a disclosed valve may operate under vacuum conditions. For example, in one non-limiting embodiment, the valve may be included in a chlorinator, such as for gas disinfection as part of a waste treatment system. The gas feeder may generally include a vacuum regulator, an injector and a valve as herein disclosed. The upstream vacuum regulator, among other features, may generally reduce a gas supply pressure to a vacuum, and function as a shut-off valve in the absence of a vacuum. A downstream injector may generally provide the operating vacuum.

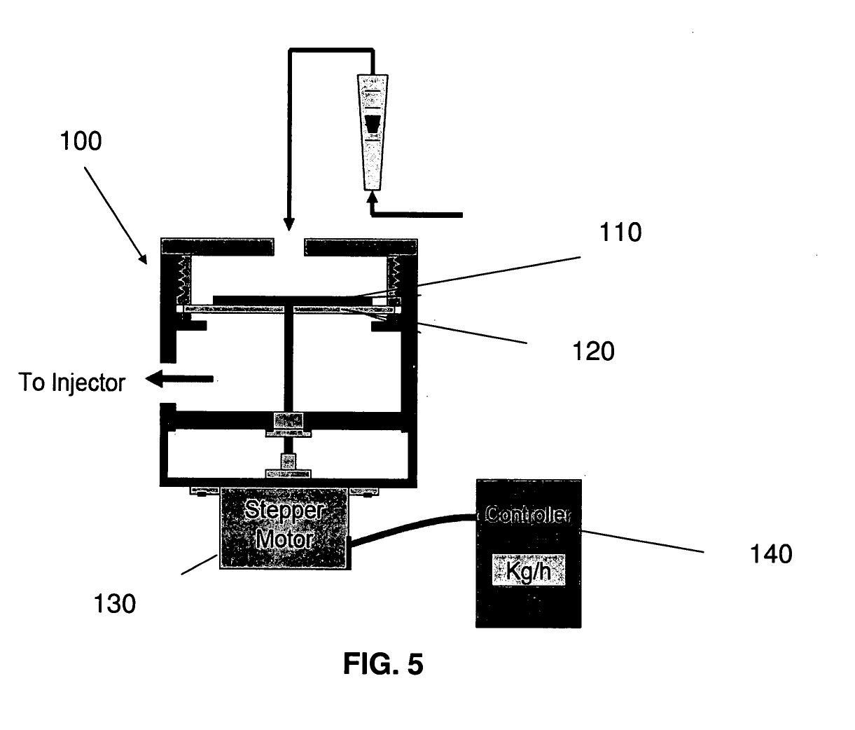

In accordance with one or more embodiments, a gas feeder incorporating a disclosed valve may operate under principles of sonic flow regulation, as illustrated in FIG. 5. A constant pressure vacuum may be maintained by an upstream vacuum regulator in conjunction with a downstream ejector so as to result in sonic conditions yielding a substantially steady fluid flow rate through valve 100. Sonic flow may generally occur when the pressure differential across the valve, or orifice, is sufficient to accelerate the fluid to acoustic velocity. A stepper motor 130 may be in mechanical communication with disc 110. Stepper motor 130 may generally adjust an orientation of disc 110 relative to orifice plate 120, such as by rotation, to regulate a fluid flow rate through valve 110. Stepper motor 130 may be in electrical communication with controller 140. Controller 140 may send a signal, such as may be based on an inputted or predetermined flow rate, to stepper motor 130 to adjust the orientation of disc 110 relative to orifice plate 120.

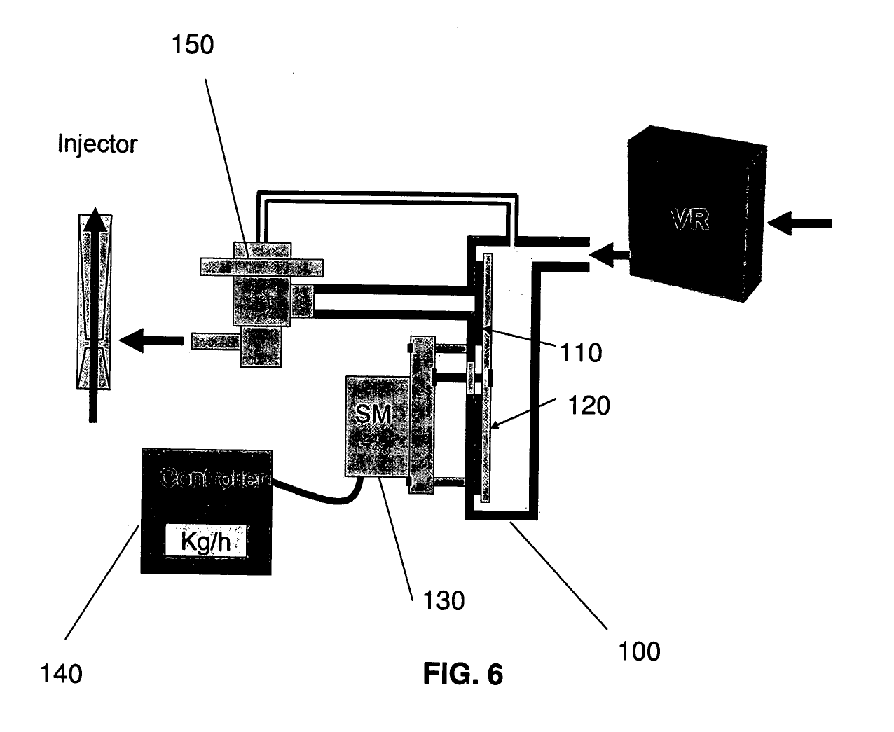

Alternatively, a gas feeder incorporating a disclosed valve may operate under principles of differential pressure regulation, as illustrated in FIG. 6. A differential pressure regulator 150 may be used across the valve 100 to maintain a steady fluid flow rate. Beneficially, a differential pressure regulator 150 may generally minimize the effect of vacuum variation or fluctuation in the system to provide a steady fluid flow rate through the valve by maintaining a constant pressure drop across the valve or orifice. As discussed above, a stepper motor 130 may be in mechanical communication with disc 110. Stepper motor 130 may generally adjust an orientation of disc 110 relative to orifice plate 120, such as by rotation, to regulate a fluid flow rate through valve 110. Stepper motor 130 may be in electrical communication with controller 140. Controller 140 may send a signal, such as may be based on an inputted or predetermined flow rate, to stepper motor 130 to adjust the orientation of disc 110 relative to orifice plate 120.

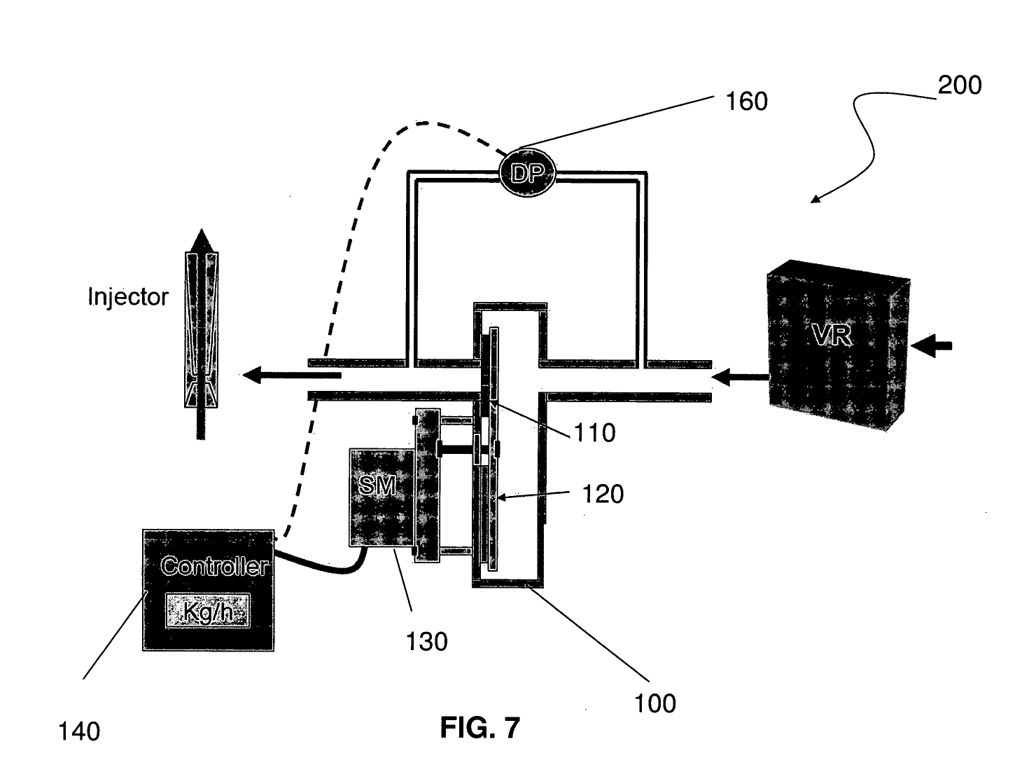

A valve in accordance with certain aspects may be incorporated into various applications. For example, principles of a disclosed valve may be implemented in a gas flow measurement device, such as rotameter 200 illustrated in FIG. 7. Device 200 may generally be efficient in determining and/or monitoring a fluid flow rate through an incorporated valve 100. Valve 100 may include an orifice plate 120 configured to facilitate fluid flow through device 200, and a disc 110 positioned adjacent to the orifice plate 120. In certain aspects, the disc 110 may be constructed and arranged to cooperate with the orifice plate 120 to maintain a substantially constant pressure drop across the orifice plate 120. Orientation of orifice plate 120 relative to disc 110 may be adjusted to maintain the substantially constant pressure drop. For example, the disc 110 may be rotatable with respect to the orifice plate 120 to maintain the substantially constant pressure drop. Device 200 may be generally responsive to changes in fluid flow rate in order to maintain a substantially constant pressure drop which may, in turn, be used to quantify and/or monitor flow rate.

A differential pressure cell 160 may be in communication with a controller 140 to detect a pressure drop across the orifice plate 120. A stepper motor 130, as described above, may be configured to adjust the orientation of the disc 110 relative to the orifice plate 120 to maintain a substantially constant pressure drop across the orifice plate 120. The controller 140 may generally communicate and/or send control signals to the stepper motor 130 to manipulate their relative orientation. For example, the controller 140 may send a control signal to the stepper motor 130 in response to the differential pressure cell 160 detecting a change in pressure drop.

A controller 140 may generally detect a fluid flow rate through the device 200 based on an orientation of the disc 110 relative to the orifice plate 120. In some aspects, the controller 140 may be configured to detect a fluid flow rate based on an effective area of an aperture in the orifice plate 120. In certain aspects, the relative orientation may generally define the effective aperture area. As discussed above, fluid flow rate may be substantially linear with respect to the orientation of the disc 110 relative to the orifice plate 120. For example, a known or established linear relationship of flow rate with respect to the relative positions of disc 110 and orifice plate 120 may facilitate determination of a flow rate through the device 200. The linear relationship may be inputted to controller 140 to facilitate flow rate detection and/or monitoring. In some aspects, controller 140 may respond to input from differential pressure cell 160 to restore a predetermined pressure drop by adjusting an orientation of disc 110 relative to orifice plate 120. Changes in such orientation may generally be correlated to changes in flow rate. Linear relationships may facilitate flow rate determination based on such orientation.

Any desired pressure drop to be maintained may be selected but should generally be unabtrusive to fluid flow, and represent a small percent of an overall operating pressure of device 200. Maintaining an optimum pressure drop may facilitate accuracy over a wider range of flow rates, by avoiding problems associated with low pressure drops. For example, accuracy at flow rates as low as 1% of full scale flow (100:1 turn-down) is achievable. In some aspects, accuracy at flow rates as low as 0.1% of full scale flow (1000:1 turn-down) is achievable. A valve may be implemented to detect flow rates over a wide range, such as from zero to a peak flow rate associated with an orifice plate used. When a different flow rate range or resolution is desired, one or more components of the valve, such as an orifice plate or disc may be substituted. Traditional differential pressure flow meters typically lose their linearity and accuracy at around 20% of full flow (turn-down ratio of 5:1). Because the pressure drop across an orifice is generally proportional to the flow rate squared, the resolution of pressure differences at low flows, compared to the differences at higher flows becomes difficult. For example, at 20% of full or peak flow, the pressure drop will only be about 4% of the pressure drop measured at full flow.

The disclosed valves may find applications in new installations, replacement and retrofit markets. Upon establishment of a linear relationship with respect to fluid flow rate as discussed herein, a master disc may be developed. Valves in accordance with one or more embodiments may be easily manufactured, for example, by simple mold and die cut from the master disc. Savings associated with lower cost of production may be beneficially passed along to end users. Furthermore, swapping of discs and/or orifice plates designed for one application or flow rate range for another may be simply performed.

The function and advantages of these and other embodiments will be more fully understood from the following prophetic example. This prophetic example is intended to be illustrative in nature and is not to be considered as limiting the scope of the systems and methods discussed herein.

### Prophetic Example

A linear relationship for a valve in accordance with one or more disclosed embodiments and aspects will be established to facilitate regulation of a fluid flow rate through the valve. Determining a linear relationship for the valve will enable enhanced accuracy and resolution of fluid flow control. Beneficially, linearization will also simplify valve design leading to ease of manufacture and lower associated costs.

For purposes of this prophetic example, it will be assumed that the operating temperature is 60° F. or 520° R. It will also be assumed that inlet and outlet piping associated with the valve has a one-inch diameter. The derivation will be further based on an assumption that chlorine gas will be metered by the valve. The valve will be assumed to include an orifice plate having an aperture with an equilateral triangle geometry. Such geometry may closely approximate a circle so that an equivalent diameter of the aperture may be assumed to simplify determination of the linear relationship.

More specifically, a linear relationship will be established wherein a fluid flow rate through the valve will vary in proportion to a height D of the equilateral triangle. The height of the triangle may be adjusted as disclosed herein, for example, by adjusting an orientation of the disc relative to the orifice plate.

The following orifice gas flow rate equation, derived from Bernoulli's Law in addition to other principles of fluid flow mechanics, will serve as a basis for establishing the linear relationship:

Qv=218.527*Cd*Ev*Y1*(d2)*[Tb/Pb]*[(Pf1*Zb*hw)/(Gr*Zf1*Tf)]0.5(3−6) Eq. 1

### Where:

Cd=Orifice plate coefficient of discharge
d=Orifice plate bore diameter calculated at flowing temperature (Tf)—in.
For triangular orifices the equivalent diameter D_{eq}=1.524*(A^{0.619})/(p^{0.235}) where A=area and P=perimeter.
   Gr=Real gas relative density (specify gravity)
   hw=Orifice differential pressure in inches of water at 60 degF
   Ev=Velocity of approach factor
   Pb=Base pressure—psia
   Pf1=Flowing pressure (upstream tap—psia)
   Qv=Standard volume flow rate—SCF/hr.
   Tb=Base temperature—degR
   Tf=Flowing temperature—degR
   Y2=Expansion factor (downstream tap)
   Zb=Compressibility at base conditions (Pb,Tb)
   Zf1=Compressibility (upstream flowing conditions—Pf1, Tf)

Substituting into Eq. 1 known constants based on typical operating principles and properties of chlorine gas will yield the following linear relationship:

Q=(218.527)(0.66(1.524(0.29D²)^{0.619}/(3.46D^{0.235}))+0.41) (π/(4(0.29D²)))(1) (1.542((0.29D2)^{0.619})/((3.46D)^{0.235}))(520/13.5) ((14)(1.355)(13.56))/((2.485)(1.355)(520)))0.5) Eq. 2

wherein Q is generally in units of standard cubic feet per minute.

A disc will be created to correspond to the established theoretical linear relationship. For example, a disc will be prepared that is capable of cooperating with an orifice plate to facilitate adjustment of the effective area or height D of the triangle based on the linear relationship to regulate flow rate. The disc will have a decreasing radius around its perimeter, ranging from a maximum radius to a minimum radius. The radii pattern of the disc will be established such that the disc can be rotated to adjust an effective area or height of the triangular aperture to regulate flow rate in accordance with the linear relationship. For example, the height of the triangle or variable D may generally correlate to the radii pattern of the disk. The correlation may depend on various factors including the size of the triangle, and position of the triangle on the orifice plate, such as the distance of the triangle from the center of the orifice plate.

When the disc is made, actual measurements and experimentation may then be used to correct for any nonidealities, such as may be due to system geometry, to adjust and perfect the linear relationship. Thus, the calculated theoretical linear relationship may be used as a starting point for iterative design of a disc for use with an orifice plate in the valve. Changes may be made to the geometry of the disc to correct for nonidealities, and a master disc will then be created for use in the valve and for the manufacture of like discs.

In designing a valve, desired maximum and minimum flow rates for the valve will be established. A maximum height D for the triangular aperture in the orifice plate will be determined to correlate with the maximum flow rate. Likewise, a minimum height D for the triangular aperture will be determined to correlate with the minimum flow rate. Maximum and minimum radii of the disc will be established such that the disc may cooperate with the orifice plate to yield both the maximum and minimum triangular aperture heights D. A range of intermediate aperture heights D will establish a linear flow rate profile for the valve, such as based on a calculated theoretical linear relationship. A radii profile or pattern of the disc, ranging from the maximum radius to the minimum radius, will be established to correlate to the range of aperture heights D to establish valve linearity. In some aspects, radii may generally be determined based on measurements from the orifice plate, dimensions of the aperture thereof, and/or experimentation. Angular position of the disc relative to the orifice plate will be correlated to flow rate. For example, a disc radius that is selected to establish a 50% flow rate may be positioned at a location of the disc corresponding to a 50% rotation. Likewise, a disc radius selected to establish a 10% flow rate may be positioned at a location of the disc corresponding to a 10% rotation.

In use, when a desired flow rate Q is known, Eq. 2 will be solved for D. The orientation of the disc relative to the orifice plate in the valve will then be adjusted so as to establish the required triangle height to yield the desired flow rate. This may be done manually. Alternatively, a linear relationship, such as one assigning a specific angular position of the disc relative to the orifice plate to various flow rates, may be input to a controller for automatic regulation. The controller may send a control signal to a stepper motor based on output of the linear relationship. The stepper motor may be calibrated such that each of its steps or intervals corresponds to a known flow rate, such as may be based on a relative position of the orifice plate to the disc.

In embodiments wherein the valve is implemented in a flow meter as described above, D will first be determined based on the relative orientation of orifice plate to disc required to maintain a constant pressure drop. D will then be used to solve Eq. 2 for Q to quantify a flow rate through the valve.

Having thus described several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

1. A rotary valve, comprising:
an orifice plate configured to facilitate fluid flow through the valve; and
a disc, positioned adjacent to the orifice plate, constructed and arranged to cooperate with the orifice plate to regulate a fluid flow rate through the valve.

2. The valve of claim 1, wherein an orientation of the disc relative to the orifice plate is adjustable to regulate the fluid flow rate.

3. The valve of claim 1, wherein the disc is constructed and arranged to cooperate with the orifice plate to regulate the fluid flow rate by adjusting an effective area of an aperture in the orifice plate.

4. The valve of claim 3, wherein the disc is rotatable relative to the orifice plate to adjust the effective area of the aperture.

5. The valve of claim 4, wherein the disc includes a section configured to engage with at least a portion of the aperture to adjust the effective area of the aperture.

6. The valve of claim 3, wherein the aperture is substantially triangular in geometry.

7. The valve of claim 5, wherein the orifice plate aperture and the disc section comprise substantially complimentary geometries.

8. The valve of claim 2, wherein the fluid flow rate through the valve is substantially linear with respect to the orientation of the disc relative to the orifice plate.

9. The valve of claim 1, wherein the disc is in mechanical communication with a stepper motor.

10. The valve of claim 9, wherein the stepper motor is in electrical communication with a controller.

11. The valve of claim 9, wherein the valve is in fluid communication with a differential pressure regulator.

12. The valve of claim 1, wherein the valve is configured to provide sonic fluid flow regulation.

13. The valve of claim 1, wherein the valve is a single-turn rotary valve.

14. The valve of claim 1, wherein the valve is fluidly connected to a source of a chlorine gas.

15. A method of metering fluid flow, comprising:
fluidly connecting a fluid source to a valve comprising an orifice plate and a disc positioned adjacent to the orifice plate; and
adjusting an orientation of the disc relative to the orifice plate to establish a predetermined fluid flow rate through the valve.

16. The method of claim 15, further comprising detecting a pressure drop across the orifice plate.

17. The method of claim 15, further comprising inputting the predetermined fluid flow rate to a controller in electrical communication with the valve.

18. The method of claim 15, wherein the predetermined fluid flow rate is less than about 10 Kg/hr−500 PPD.

19. A fluid flow rate measurement device, comprising:
an orifice plate configured to facilitate fluid flow through the device;
a disc, positioned adjacent to the orifice plate, constructed and arranged to cooperate with the orifice plate to maintain a substantially constant pressure drop across the orifice plate; and
a controller configured to detect a fluid flow rate through the device based on an orientation of the disc relative to the orifice plate.

20. The device of claim 19, wherein the disc is rotatable with respect to the orifice plate to maintain the substantially constant pressure drop across the orifice plate.

21. The device of claim 19, wherein the controller is configured to detect the fluid flow rate based on an effective area of an aperture in the orifice plate.

22. The device of claim 21, wherein the detected fluid flow rate is substantially linear with respect to the orientation of the disc relative to the orifice plate.

23. The device of claim 19, wherein the controller is configured to detect an actual flow rate of less than about 1% of a peak fluid flow rate.

24. The device of claim 19, wherein the device further comprises a stepper motor configured to adjust the orientation of the disc relative to the orifice plate to maintain the substantially constant pressure drop across the orifice plate.

25. The device of claim 24, wherein the device further comprises a differential pressure cell in communication with the stepper motor.
